(19) United States
(12) Patent Application Publication
(10) Pub. No.: US 2026/0332768 A1
(43) Pub. Date: Oct. 22, 2026

(54) METHODS FOR SYNONYMOUS IMAGE COMPRESSION ENCODING, DECODING, AND ENCODER-DECODER MODEL TRAINING

(71) Applicant: Beijing University of Posts and Telecommunications, Beijing (CN)

(72) Inventors: Kai NIU, Beijing (CN); Zijian LIANG, Beijing (CN); Changshuo WANG, Beijing (CN); Jin XU, Beijing (CN); Ping ZHANG, Beijing (CN)

(73) Assignee: Beijing University of Posts and Telecommunications, Beijing (CN)

(21) Appl. No.: 19/249,764

(22) Filed: Jun. 25, 2025

(30) Foreign Application Priority Data
Apr. 22, 2025 (CN) 202510507302.6

(51) Int. Cl. H04N 19/13; G06T 9/00; H04N 19/119; H04N 19/124; H04N 19/91

(52) U.S. Cl. CPC H04N 19/13; G06T 9/002; H04N 19/119; H04N 19/124; H04N 19/91

(57) ABSTRACT

A method for synonymous image compression encoding includes: determining a continuous latent feature map corresponding to an image to be encoded; quantizing the continuous latent feature map to obtain a quantized feature map corresponding to the image; dividing the quantized feature map into a synonymous representation section and a detailed representation section; and encoding the synonymous representation section to obtain an encoded sequence.

### CROSS-REFERENCE TO RELATED APPLICATIONS

This application claims priority to Chinese Patent Application No. 202510507302.6, filed on Apr. 22, 2025, the content of which is incorporated herein by reference in its entirety.

### TECHNICAL FIELD

The present disclosure relates to communication technologies, and in particularly, to a method for synonymous image compression encoding, a method for synonymous image compression decoding, and a method for encoder-decoder model training.

### BACKGROUND

With a widespread adoption of Internet and mobile devices, transmission volumes of images have increased dramatically. However, information represented by images, due to its large data volume, generally requires an image compression encoding algorithm at an encoder to compress the image into compact data streams or files. Only through an image compression encoding can the image be transmitted via the Internet or other media to a decoder, where a corresponding image compression decoding algorithm can be employed for an image reconstruction. Currently, the image compression technique has become a critical research topic in modern Internet-based visual applications.

### SUMMARY

In view of the above, examples of the present disclosure provide a method for synonymous image compression encoding, a method for synonymous image compression decoding, and a method for encoder-decoder model training, which can achieve efficient and accurate image compressions, therefore a transmission efficiency of images over the Internet can be greatly improved.

The method for synonymous image compression encoding according to some examples of the present disclosure may include: determining a continuous latent feature map corresponding to an image to be encoded; quantizing the continuous latent feature map to obtain a quantized feature map corresponding to the image; dividing the quantized feature map into a synonymous representation section and a detailed representation section; and encoding the synonymous representation section to obtain an encoded sequence.

In some examples of the present disclosure, determining the continuous latent feature map corresponding to the image to be encoded may include: using the image as an input to an analysis transform network; performing an analysis transform on the image by the analysis transform network; and outputting the continuous latent feature map corresponding to the image by the analysis transform network.

In some examples of the present disclosure, quantizing the continuous latent feature map to obtain a quantized feature map corresponding to the image may include: for each symbol in the continuous latent feature map, quantizing the symbol to a predetermined quantization level closest to a value of the symbol to obtain a quantized symbol corresponding to the symbol; and sorting quantized symbols obtained according to an arrangement order of the symbols in the continuous latent feature map to obtain the quantized feature map.

In some examples of the present disclosure, the continuous latent feature map may include: a continuous synonymous representation portion and a continuous detailed representation portion. Quantizing the continuous latent feature map to obtain a quantized feature map corresponding to the image may include: quantizing the continuous synonymous representation portion to obtain a quantized synonymous representation portion, and quantizing the continuous detailed representation portion to obtain a quantized detailed representation portion. Moreover, dividing the quantized feature map into a synonymous representation and a detailed representation may include: taking the quantized synonymous representation portion as the synonymous representation section; and taking the quantized detailed representation portion as the detailed representation section.

In some examples of the present disclosure, the continuous latent feature map may include: L sets of continuous representation portions corresponding to L synonymous levels; where, L is a positive integer; the quantized feature map may include: L sets of quantized representation portions corresponding to L synonymous levels; dividing the quantized feature map into the synonymous representation section and the detailed representation section comprises: arranging the L sets of quantized representation portions from a high degree of importance to a low degree of importance; selecting a first M sets of quantized representation portions as the synonymous representation section; wherein, M is a pre-set positive integer and is less than or equal to L; and taking un-selected sets of quantized representation portions as the detailed representation section.

In some examples of the present disclosure, the continuous latent feature map may include: L sets of continuous representation portions corresponding to L synonymous levels; where, L is a positive integer; the quantized feature map may include: L sets of quantized representation portions corresponding to L synonymous levels; dividing the quantized feature map into the synonymous representation section and the detailed representation section comprises: arranging the L sets of quantized representation portions from a low degree of importance to a high degree of importance; selecting a last L−M+1 sets of quantized representation portions as the synonymous representation section; wherein, M is a pre-set positive integer and is less than or equal to L; and taking un-selected sets of quantized representation portions as the detailed representation section.

In some examples of the present disclosure, the method for synonymous image compression encoding may further include: transforming the continuous latent feature map from a latent domain to a frequency domain to obtain a frequency domain feature map; dividing the frequency domain feature map into a synonymous frequency domain portion and a detailed frequency domain portion based on a pre-set frequency threshold; transforming the synonymous frequency domain portion from the frequency domain to the latent domain to obtain a continuous synonymous representation portion; and transforming the detailed frequency domain portion from the frequency domain to the latent domain to obtain a continuous detailed representation portion. Quantizing the continuous latent feature map to obtain a quantized feature map corresponding to the image may include: quantizing the continuous synonymous representation portion to obtain a quantized synonymous representation portion, and quantizing the continuous detailed representation portion to obtain a quantized detailed representation portion. Moreover, dividing the quantized feature map into a synonymous representation and a detailed representation may include: taking the quantized synonymous representation portion as the synonymous representation section; and taking the quantized detailed representation portion as the detailed representation section.

In some examples of the present disclosure, encoding the synonymous representation to obtain the encoded sequence may include: estimating a probability of each quantized symbol in the synonymous representation section; and performing an entropy encoding on the synonymous representation section based on the probability of each quantized symbol in the synonymous representation section to obtain the encoded sequence.

In some examples of the present disclosure, the encoded sequence may further include: an encoding codebook carrying information about the probability of each quantized symbol in the synonymous representation section, or side information carrying information about the probability of each quantized symbol in the synonymous representation section.

The method for synonymous image compression decoding according to some examples of the present disclosure may include: decoding an encoded sequence to obtain a reconstructed synonymous representation section corresponding to the encoded sequence; reconstructing one or more than one reconstructed detailed representation section relied on the reconstructed synonymous representation section; integrating the one or more than one reconstructed synonymous representation section with the reconstructed detailed representation section to obtain one or more than one reconstructed feature map; and reconstructing one or more than one reconstructed image based on the one or more than one reconstructed feature map.

In some examples of the present disclosure, decoding the encoded sequence to obtain the reconstructed synonymous representation section corresponding to the encoded sequence may include: performing an entropy decoding on the encoded sequence to obtain the reconstructed synonymous representation section.

In some examples of the present disclosure, reconstructing one or more than one reconstructed detailed representation section relied on the reconstructed synonymous representation section: using the reconstructed synonymous representation section as an input to a detail reconstruction network; predicting the one or more than one reconstructed detailed representation section by the detail reconstruction network; and outputting the one or more than one reconstructed detailed representation section corresponding to the encoded sequence by the detail reconstruction network.

In some examples of the present disclosure, reconstructing one or more than one reconstructed detailed representation section corresponding to the encoded sequence may include: sampling quantized symbols in a quantized symbol set to determine each quantized symbol included in every reconstructed detailed representation section.

In the method for encoder-decoder model training described in some examples of the present disclosure, the encoder-decoder model may include: an analysis transform network and a synthesis transform network. The method for encoder-decoder model training may include: selecting a sample image from a training dataset; inputting the sample image into the analysis transform network to obtain a continuous latent feature map; inputting the continuous latent feature map into a quantizer to obtain a quantized feature map; dividing the quantized feature map into a synonymous representation section and a detailed representation section; determining a probability of each quantized symbol in the synonymous representation section; determining a compression rate of the synonymous representation section based on the probability of each quantized symbol in the synonymous representation section; estimating at least one reconstructed detailed representation based on the synonymous representation section; integrating the synonymous representation section with the at least one reconstructed detailed representation section to obtain at least one reconstructed feature map; inputting the at least one reconstructed feature map into the synthesis transform network respectively to obtain at least one reconstructed image; calculating an average distortion and an average perceptual loss based on the sample image and the at least one reconstructed image; calculating a weighted loss based on the compression rate, the average distortion, and the average perceptual loss; performing a gradient backpropagation; and using a gradient descent algorithm to update parameters in the encoder-decoder model.

In some examples of the present disclosure, calculating the average distortion based on the sample image and the at least one reconstructed image may include: for each of the at least one reconstructed image \tilde{x}ⱼ, calculating a distortion matric between the sample image x and the reconstructed image \tilde{x}ⱼ to obtain at least one distortion matric, and calculating the average of the at least one distortion matric [symbol] _{\tilde{x}}_{ⱼ}_{∈}\tilde{x}[d(x,\tilde{x}ⱼ)] as the average distortion. Calculating the average perceptual loss based on the sample image and the at least one reconstructed image may include: for each of the at least one reconstructed image \tilde{x}ⱼ, calculating a perceptual loss between the sample image x and the reconstructed image \tilde{x}ⱼ to obtain at least one perceptual loss, and calculating the average of the at least one perceptual loss [symbol] _{\tilde{x}}_{ⱼ}_{∈}\tilde{x}[dₚ(pₓ,p_{\tilde{x}}_{ⱼ})] as the average perceptual loss.

In some examples of the present disclosure, calculating the weighted loss based on the compression rate, the average distortion, and the average perceptual loss may include: determining the weighted loss [symbol] ₓ based on the following expression:

[symbol]

ₓ=λ_{d}· [symbol] _{\tilde{x}}_{ⱼ}_{∈}\tilde{x}[d(x,\tilde{x}ⱼ)]+λₚ· [symbol] _{\tilde{x}}_{ⱼ}_{∈}\tilde{x}[dₚ(pₓ,p_{\tilde{x}}_{ⱼ})]+λᵣ·R(ŷₛ)

Where, λ_{d} represents a weighted coefficient of the average distortion; λₚ represents a weighted coefficient of the average perceptual loss; λᵣ represents a weighted coefficient of the compression rate; and R(ŷₛ) represents the compression rate.

In some examples of the present disclosure, calculating the weighted loss based on the compression rate, the average distortion, and the average perceptual loss may include: determining a weighted loss of a |^{th} synonymous level [symbol] ₓ^{(l)} based on the following expression:

[symbol]

ₓ^{(l)}=λ_{d}^{(l)}· [symbol] _{\tilde{x}}_{ⱼ}_{∈}\tilde{x}[d(x,\tilde{x}ⱼ)]+λ_{d}^{(l)}· [symbol] _{\tilde{x}}_{ⱼ}_{∈}\tilde{x}[dₚ(pₓ,p_{\tilde{x}}_{ⱼ})]+λᵣ^{(l)}·R(ŷₛ)

Where,

$${λ}_{d}^{( l )}$$

represents a weighted coefficient of an average distortion of the |^{th} synonymous level;

$${λ}_{p}^{( l )}$$

represents a weighted coefficient of an average perceptual loss of the |^{th} synonymous level;

$${λ}_{r}^{( l )}$$

represents a weighted coefficient of a compression rate of the |^{th} synonymous level; and R(ŷₛ) represents the compression rate;
determining the weighted loss [symbol] ₓ based on the following expression:

[symbol]

ₓ=α⁽¹⁾· [symbol] ₓ⁽¹⁾+α⁽²⁾· [symbol] ₓ⁽²⁾+ . . . +α^{(L)}· [symbol] ₓ^{(L)}

Where, α⁽¹⁾,α⁽²⁾, . . . α^{(L)} represent weight coefficients corresponding to each synonymous level 1, 2, . . . , L, respectively; and for each l, α(l)≥0. It can be seen from the above description, based on the method for synonymous image compression encoding disclosed, a synonymous image compression can be performed on an image according to specific average distortion constraints and specific average perceptual loss constraints. In addition, through the method for synonymous image compression decoding disclosed, a reconstructed image with a certain reconstruction distortion and a certain perceptual loss can be obtained. Through the methods disclosed, an efficient and accurate image compression can be achieved, and the efficiency of image transmissions in the Internet can be improved. In addition, through the method for encoder-decoder model training, the analysis transform network used in the method for synonymous image compression encoding, the synthesis transform network used in the method for synonymous image compression decoding can be obtained. Further, an optional probability estimation network or an optional detail reconstruction network can also be obtained. In this way, the method for synonymous image compression encoding and the method for synonymous image compression decoding can be supported effectively.

### BRIEF DESCRIPTION OF THE DRAWINGS

To illustrate technical solutions of the present disclosure or the prior art more clearly, drawings used in examples or the prior art will be briefly introduced. Obviously, the drawings in the following description are only some examples of the present disclosure. For those of ordinary skill in the art, other drawings may be obtained based on these drawings without creative effort.

FIG. 1 is a flowchart of a method for synonymous image compression encoding according to an example of the present disclosure.

FIG. 2 is a flowchart of a method for synonymous image compression decoding according to an example of the present disclosure.

FIG. 3 is a flowchart of a method for encoder-decoder model training according to an example of the present disclosure.

FIG. 4a and FIG. 4b illustrate perceptual quality curves at different compression rates corresponding to the method for synonymous image compression encoding, the method for synonymous image compression decoding, and traditional image compression schemes according to some examples of the present disclosure.

FIG. 4c illustrates reconstructed images at different synonymous levels corresponding to the method for synonymous image compression encoding and the method for synonymous image compression decoding according to some examples of the present disclosure.

FIG. 5 is a structural diagram of a synonymous image compression encoding device according to an example of the present disclosure.

FIG. 6 is a structural diagram of a synonymous image compression decoding device according to an example of the present disclosure.

FIG. 7 is a hardware structure diagram of an electronic device according to an example of the present disclosure.

### DETAILED DESCRIPTION OF THE EMBODIMENTS

To make the objectives, technical solutions, and advantages of the present disclosure clearer, the following further describes the present disclosure in detail with reference to specific examples and accompanying drawings.

It should be noted that, unless otherwise defined, technical terms or scientific terms used in the examples of the present disclosure shall have the ordinary meanings understood by persons skilled in the art. The terms “first,” “second,” and similar terms used in the examples of the present disclosure do not denote any order, quantity, or importance, but are merely used to distinguish different components. The terms “comprising” or “including” and similar terms mean that elements or items preceding the term encompass elements or items listed after the term and their equivalents, but do not exclude other elements or items. The terms “connected” or “coupled” and similar terms are not limited to physical or mechanical connections, but may include electrical connections, whether direct or indirect. Terms such as “upper,” “lower,” “left,” and “right” are used only to indicate relative positional relationships. When the absolute position of the described object changes, the relative positional relationship may also change accordingly.

For clarity of the description, before describing specific technical solutions of the present disclosure, it is necessary to explain some terms involved in the present disclosure at first.

A latent feature map of an image may be a continuous, high-dimensional feature representation extracted through a deep learning model, such as a convolutional neural network (CNN), a recurrent neural network (RNN) network or a transformer-based network, and etc. The latent feature map differs from a traditional discrete pixel feature map or an explicit feature map in many aspects.

Entropy encoding may refer to a lossless data compression technique based on information entropy theory, which is widely used in fields of text, image, and video compression. The core idea of entropy encoding is to represent information by reducing data redundancies efficiently.

As mentioned above, the image compression technique has become an important research topic in Internet vision applications. At present, image compression methods may be mainly divided into two types: algorithms based on human designs and methods based on neural networks. Among them, algorithms based on human designs, such as Joint Photographic Experts Group (JPEG) or Better Portable Graphics (BPG), use a rate-distortion optimization criterion in the classical Shannon information theory to achieve an optimal balance between a compression rate and a pixel level distortion through operations such as linear predictions, decorrelation transformations, quantization, entropy encodings, and etc. The methods based on neural networks take an autoencoder structure based on a deep neural network as a basic framework, and realize an end-to-end optimization by designing a loss function that balances rate distortions, thereby achieving a better rate distortion performance than the algorithms based on human designs.

In recent years, with the development of generative artificial intelligence technologies, researchers have found that a reconstructed image with a high perceptual similarity may have a significant distortion compared to an original image. In other words, a high degree of distortion does not necessarily mean a poor perceptual quality. That is, there is a trade-off between distortions and perceptual losses. Therefore, based on this empirical discovery, a perceptual image compression method may be proposed to minimize a compression rate under certain distortion constraints and certain perceptual loss constraints, thereby a balance among compression rates, distortions and perceptual losses can be achieved. Although the perceptual image compression method may break the constraints of symbol level distortions in reconstructed images and lean more towards semantic information processing, there is no semantic information theory to guild the framework design currently.

With a revelation of synonymous nature of semantic information, semantic information processing criteria based on synonymy can be used to establish a theoretical analysis framework for perceptual image compressions, which may reveal a processing logic of perceptual image compressions based on semantic information. The semantic information processing criteria may point out theoretical optimization directions and guiding directions for perceptual image compression designs. Perceptual image compressions can be achieved by using images that have perceptual similarities to an original image (i.e. an image to be encoded) as an ideal synonymous set, and using common features of all images in the ideal synonymous set as an object of a compression. A reconstruction of an image can be obtained through predictions, samplings, and other operations to determine an image in the ideal synonymous set. In this way, the reconstructed image may have a certain perceptual similarity to the original image. Under this framework, perceptual image compressions can be theoretically derived to establish an optimization direction that balances a synonymous rate, an average distortion, and an average perceptual loss for perceptual image compressions.

Based on the above reasons, examples of the present disclosure propose a new perceptual image compression method from a perspective of synonymous semantic information, also known as a method for synonymous image compression encoding and a method for synonymous image compression decoding.

The method for synonymous image compression encoding and the method for synonymous image compression decoding according to examples of the present disclosure will be explained in detail with reference to the accompanying drawings. For the convenience of description, in the disclosed examples, the method for synonymous image compression encoding may be implemented by a synonymous image compression encoder in an encoding end. The method for synonymous image compression decoding may be implemented by a synonymous image compression decoder in a decoding end. The encoding end may be considered as an equivalent to a sending end, and the decoding end may be considered as an equivalent to a receiving end in other image compression methods.

A main process of the method for synonymous image compression encoding disclosed may be summarized as follows. Firstly, multiple steps such as an analysis transform, a quantization, and a synonymous representation determination may be performed. Therefore, latent features shared by all images in the ideal synonymous set corresponding to the original image may be selected as a synonymous representation section of the image. Then, the synonymous representation section of the image may be compressed and encoded to achieve synonymous image compression of the image.

FIG. 1 is a flowchart of a method for synonymous image compression encoding according to an example of the present disclosure. As shown in FIG. 1, the method for synonymous image compression encoding disclosed may include the following steps.

In block 110, a continuous latent feature map corresponding to an image to be encoded is determined.

In the disclosed example, a continuous latent feature map corresponding to the image to be encoded can be obtained by performing an analysis transform on the image to be encoded. In some examples of the present disclosure, the analysis transform may be understood as a non-linear transform. Thus, in the disclosed examples, if the analysis transform is represented by g_{α}(·), the analysis transform of the image described in block 110 can be expressed as the following analysis transform process: y=g_{α}(x). Where, x can represent the image to be encoded, which can be represented as a three-dimensional real matrix x∈ [symbol] ^{C×H×W} with C channels, a height of H, and a width of W, where [symbol] represents a real space; y can represent the continuous latent feature map corresponding to the image, which can be represented as a three-dimensional real matrix y∈ [symbol] ^{c×h×w} with C channels, a height of H, and a width of W. It can be understood that the analysis transform g_{α}(·) should have an ability to transform the image x into the continuous latent feature map y.

In some examples of the present disclosure, the analysis transform can be performed based on a neural network including but not limited to a convolutional neural network (CNN), a recurrent neural network (RNN), or a transformer. One of these neural networks may be used to construct an analysis transform network that can achieve the above nonlinear transform. It can be understood that the analysis transform network may contain trainable parameters, and the parameters can be optimized through a training process provided in some examples of the present disclosure, so that the analysis transform network trained may have the ability to transform the image X into the continuous latent feature map y. The training method for the analysis transform network will be described in detail in the following.

It should be noted that in some examples of the present disclosure, constraints may be imposed on the analysis transform network during the training process, so that the continuous latent feature map output by the analysis transform network may include a continuous synonymous representation portion and a continuous detailed representation portion. Among them, the continuous synonymous representation portion may refer to shared latent features of all images in the ideal synonymous set [symbol] corresponding to the image to be encoded. The continuous detailed representation portion can be information in the continuous feature map other than the continuous synonymous representation portion. Specifically, in some examples, as mentioned earlier, a continuous latent feature map may be represented as a three-dimensional real matrix with C channels, a height of H, and a width of W. Therefore, during the training process, the analysis transform network can be constrained so that some channels of the C channels in the continuous latent feature map output by the analysis transform network may be designated as the continuous synonymous representation portion; and other non-designated channels may be taken as the continuous detailed representation portion. In this way, the continuous latent feature map may be divided into a continuous synonymous representation portion and a continuous detailed representation portion by designating channels of the continuous latent feature map as the continuous synonymous representation portion.

In other examples of the present disclosure, constraints can also be imposed on the analysis transform network during the training process, so that the continuous latent feature map output by the analysis transform network can be separated into L sets of continuous representation portions. That is, the continuous latent feature map may be divided into L sets of continuous representation portions corresponding to L synonymous levels respectively. Moreover, based on degrees of importance, the L sets of continuous representation portions may be sorted from a high degree of importance to a low degree of importance as y^{(l)},l=1, 2, . . . ,L. Alternatively, as an alternative example, the L sets of continuous representation may be sorted from a low degree of importance to a high degree of importance as y^{(l)},l=1, 2, . . . ,L. L may be a pre-set positive integer. It should be noted that the above two kinds of arrangements according to degrees of importance are equivalent.

In some other examples of the present disclosure, after the step in block 110, the method for synonymous image compression encoding may further include: transforming the continuous latent feature map from a latent domain to a frequency domain to obtain a frequency domain feature map; dividing the frequency domain feature map into a synonymous frequency domain portion and a detailed frequency domain portion based on a pre-set frequency threshold; transforming the synonymous frequency domain portion from the frequency domain to the latent domain to obtain a continuous synonymous representation portion; and transforming the detailed frequency domain portion from the frequency domain to the latent domain to obtain a continuous detailed representation portion. Specifically, the operation of transforming the continuous latent feature map from a latent domain to a frequency domain to obtain a frequency domain feature map may be implemented by a discrete cosine transform (DCT). The operation of transforming the synonymous frequency domain portion from the frequency domain to the latent domain to obtain a continuous synonymous representation portion may be implemented by an inverse discrete cosine transform (IDCT). Moreover, in the process of dividing the frequency domain feature map into a synonymous frequency domain portion and a detailed frequency domain portion based on a pre-set frequency threshold, the portion with a frequency lower than the frequency threshold may be regarded as the synonymous frequency domain portion, while the portion with a frequency higher than or equal to the frequency threshold may be regarded as the detailed frequency domain portion. That is to say, in the above example, a low-frequency portion of the continuous latent feature map can be separated as the continuous synonymous representation portion, while a high-frequency portion of the continuous latent feature map can be separated as the continuous detailed representation portion. In addition, the frequency threshold can be set arbitrarily according to actual needs, and the specific value of the frequency threshold is not limited in examples of the present disclosure.

In block 120, the continuous latent feature map is quantized to obtain a quantized feature map corresponding to the image.

In some examples of the present disclosure, the quantization may be implemented by a method such as a uniform quantization or a non-uniform quantization.

In some examples of the present disclosure, the process of quantizing the continuous latent feature map by the uniform quantization may include the following steps. Multiple quantization levels may be set in advance. Moreover, an integer value may be assigned as a quantized symbol for each quantization level. Among them, the interval between multiple quantization levels may be uniform. Each symbol in the continuous latent feature map may be quantized to a quantization level closest to a value of the symbol. The integer value corresponding to the quantization level may then be taken as the quantized symbol of the symbol. Symbol by symbol, the quantized symbol corresponding to each symbol in the continuous latent feature map may be obtained. Then, all quantized symbols obtained after quantization may be arranged in the order of symbols in the continuous latent feature map y to obtain the quantized feature map ŷ∈ [symbol] ^{c×h×w} corresponding to the image to be encoded, where [symbol] may represent the integer space. In other examples, rounding can also be used to quantize each symbol with a floating-point value in the continuous latent feature map. As an alternative to the above, the quantization level can also be directly used as the quantized symbol. In this case, the quantized feature map ŷ∈ [symbol] ^{c×h×w} corresponding to the image to be encoded is obtained. It should be noted that although the quantized symbols obtained after quantization belong to the real space, their numerical range is limited, only to the real values of the given quantization level.

Similar to the uniform quantization methods, the process of quantizing the continuous latent feature map by the non-uniform quantization may also include the following steps. Multiple quantization levels may be set in advance. Moreover, an integer value may be assigned as a quantized symbol for each quantization level. Among them, the interval between multiple quantization levels may be non-uniform. Each symbol in the continuous latent feature map may be quantized to a quantization level closest to a value of the symbol. The integer value corresponding to the quantization level may then be taken as the quantized symbol of the symbol. Symbol by symbol, the quantized symbol corresponding to each symbol in the continuous latent feature map may be obtained. Then, all quantized symbols obtained after quantization may be arranged in the order of symbols in the continuous latent feature map y to obtain the quantized feature map ŷ∈ [symbol] ^{c×h×w} corresponding to the image to be encoded. As an alternative to the above, the quantization level can also be directly used as the quantized symbol. In this case, the quantized feature map ŷ∈ [symbol] ^{c×h×w} corresponding to the image to be encoded is obtained. It should be noted that although the quantized symbols obtained after quantization belong to the real space, their numerical range is limited, only to the real values of the given quantization level.

In addition, as mentioned earlier, in some examples of the present disclosure, by training the analysis transform network, the continuous latent feature map output by the analysis transform network may be divided into a continuous synonymous representation portion and a continuous detailed representation portion. Alternatively, in some other examples of the present disclosure, the continuous latent feature map corresponding to the image to be encoded can also be divided into a continuous synonymous representation portion and a continuous detailed representation portion by performing transformations on the continuous latent feature map. In these cases, after the quantization process, the quantized feature map corresponding to the image to be encoded can also be divided into a quantized synonymous representation portion and a quantized detailed representation portion. Specifically, the process of quantifying the continuous latent feature map to obtain the quantized feature map corresponding to the image to be encoded as described in block 120 may include: quantizing the continuous synonymous representation portion to obtain the quantized synonymous representation portion, and quantizing the continuous detailed representation portion to obtain the quantized detailed representation portion. In these examples, a combination of the quantized synonymous representation portion and the quantized detailed representation portion would be the quantized feature map. For example, if during the training process, the analysis transform network is constrained so that some specific channels in the continuous latent feature map output by the analysis transform network may be designated as the continuous synonymous representation portion, while other channels may be designated as the continuous detailed representation portion. In this way, after performing the quantization process on the continuous synonymous representation portion, the quantized synonymous representation portion can be obtained; and after performing the quantization process on the continuous detailed representation portion, the quantized detailed representation portion can be obtained.

In some other examples of the present disclosure, if constraints are imposed on the analysis transform network during training to separate the continuous latent feature map output by the analysis transform network into L sets of continuous representation portions. In this way, after performing the quantization operations on the L sets of continuous representation portions, L sets of quantized representation portions may be obtained. Moreover, based on degrees of importance, the L sets of quantized representation may be sorted from a high degree of importance to a low degree of importance as ŷ^{(l)},l=1, 2, . . . ,L. Alternatively, as an alternative example, the L sets of quantized representation may be sorted from a low degree of importance to a high degree of importance as ŷ^{(l)},l=1, 2, . . . ,L. L may be a pre-set positive integer. It should be noted that the above two kinds of arrangements of degrees of importance are equivalent.

In block 130, the quantized feature map is divided into a synonymous representation section and a detailed representation section.

In some examples of the present disclosure, the synonymous representation section may be represented as ŷₛ, which may be the shared latent space feature ŷₛ of all images in the ideal synonymous set [symbol] corresponding to the image to be encoded. The information other than the shared latent space feature ŷₛ in the quantized feature map ŷ may be regarded as the detailed representation section Se of the image to be encoded. It should be noted that, in examples of the present disclosure, an average distortion of all images in the ideal synonymous set χ and the original image (i.e. the image to be encoded) should satisfy a condition: [symbol] ₓ_{ᵢ}_{∈}x[d(x,xᵢ)]≤D, and an average perceptual loss should satisfy another condition: [symbol] ₓ_{ᵢ}_{∈}x[dₚ(pₓ,pₓ_{ᵢ})]≤P. Among them, xᵢ represents an i^{th} image in the ideal synonymous set χ; d(·) represents a distortion metric function; d(x,xᵢ) represents a distortion between the i^{th} image xᵢ in the ideal synonymous set χ and the image x to be encoded; D represents a distortion threshold; [symbol] represents a mathematical expectation; dₚ(·) represents a perceptual loss metric function; dₚ(pₓ,pₓ_{ᵢ}) represents a perceptual loss metric between the i^{th} image xᵢ in the ideal synonymous set X and the image x to be encoded; P represents a perceptual loss threshold. In some examples disclosed, the distortion metric function can be implemented by one of the following distortion metric methods such as mean square error function (MSE), multi-scale structural similarity function (MS-SSIM), and etc. In some examples disclosed, the above perceptual loss metric function can be implemented by divergence calculation methods such as relative entropy (or KL divergence), Wasserstein divergence, JS divergence, or by one of perceptual indicators such as LPIPS or DISTS that is close to a perceptual quality.

It should be noted that in some examples of the present disclosure, the synonymous representation section ŷₛ may be identical to the quantized feature map ŷ, in which case there would be no detailed representation section ŷ_{ε}.

As mentioned above, in some examples of the present disclosure, by training the analysis transform network, the continuous latent feature map output by the analysis transform network may be divided into a continuous synonymous representation portion and a continuous detailed representation portion. Alternatively, in some other examples of the present disclosure, the continuous latent feature map corresponding to the image to be encoded can also be divided into a continuous synonymous representation portion and a continuous detailed representation portion by performing transformations on the continuous latent feature map. In these cases, after the quantization process, the quantized feature map corresponding to the image to be encoded can also be divided into a quantized synonymous representation portion and a quantized detailed representation portion. Thus, in block 130, the quantified synonymous representation portion can be taken as the synonymous representation section, while the quantified detailed representation portion can be taken as the detailed representation section.

Also as mentioned above, in some other examples of the present disclosure, if constraints are imposed on the analysis transform network during training to separate the continuous latent feature map output by the analysis transform network into L sets of continuous representation portions. In this way, after performing the quantization operations on the L sets of continuous representation portions, L sets of quantized representation portions may be obtained. Moreover, based on degrees of importance, the L sets of quantized representation portions may be sorted from a high degree of importance to a low degree of importance as ŷ^{(l)},l=1, 2, . . . ,L. Then, by setting a value of M and selecting a first M sets of quantized representation portions

$${\hat{y}}_{s}^{( M )}$$

as the synonymous representation section ŷₛ corresponding to a synonymous level M, and taking the un-selected quantized representation portion

$${\hat{y}}_{ε}^{( M )}$$

as the detailed representation section ŷ_{ε}. Among them, the synonymous representation section ŷₛ corresponding to the synonymous level M should refer to shared latent space features of all images in the ideal synonymous set corresponding to the image to be encoded. M is a pre-set positive integer, and M should be less than or equal to L. Moreover, an average distortion between each of the images in the ideal synonymous set and the image to be encoded should satisfy a condition: [symbol] ₓ_{ᵢ}_{∈}x[d(x,xᵢ)]≤D^{(M)}. In some examples, the distortion metric function mentioned above may be mean square error function (MSE), multi-scale structural similarity function (MS-SSIM), and etc. In addition, an average perceptual loss between each of the images in the ideal synonymous set and the image to be encoded should satisfy the following condition: [symbol] ₓ_{ᵢ}_{∈}x[dₚ(pₓ,pₓ_{ᵢ})]≤P^{(M)}. D^{(M)} represents a distortion threshold corresponding to the synonymous level M. P^{(M)} represents a perceptual loss threshold corresponding to the synonymous level M. Further, the above relationship needs to meet the following two conditions:

D⁽¹⁾≥D⁽²⁾≥ . . . ≥D^{(L)}

p⁽¹⁾≥p⁽²⁾≥ . . . ≥p^{(L)}

It should be noted that, as an alternative example, the L sets of quantized representation portions may be sorted from a low degree of importance to a high degree of importance as ŷ^{(l)}, l=1, 2, . . . ,L. In this case, it is also possible to set a value of M and select a last L−M+1 sets of quantized representation portions, including the M^{th} set, as the synonymous representation section ŷₛ, and take the un-selected quantized representation portion as the detailed representation section ŷ_{ε}. This method is completely equivalent to the method disclosed above. The relationships shown in the two conditions mentioned above still needs to be satisfied.

In block 140, the synonymous representation section is encoded to obtain an encoded sequence.

In some examples of the present disclosure, encoding the synonymous representation section may include encoding the synonymous representation section through an entropy encoding. Specifically, the entropy encoding may be performed symbol by symbol on the synonymous representation section. The entropy encoding of the synonymous representation section may include: estimating a probability of each quantized symbol in the synonymous representation section; and performing an entropy encoding on the synonymous representation section based on the probability of each quantized symbol in the synonymous representation to obtain the encoded sequence b.

In some examples of the present disclosure, the method for estimating the probability of each quantized symbol in the synonymous representation can be implemented by a statistical method or a probability estimation method based on a neural network. Specifically, when estimating the probability of each quantized symbol in the synonymous representation section through a statistical method, the number of times of each quantized symbol appearing in the synonymous representation section can be counted. Therefore, a frequency of each quantized symbol appearing in the synonymous representation section can be calculated and used as the probability of each quantized symbol in the synonymous representation section. In the method of estimating the probability of each quantized symbol in the synonymous representation section through a probability estimation method based on a neural network, the neural network used for probability estimation can be referred to as a probability estimation network. It can be understood that the probability estimation network may contain trainable parameters internally, and the parameters can be optimized through the training method provided in some examples of the present disclosure, so that the probability estimation network trained may have the ability to estimate the probability of each quantized symbol in the synonymous representation section. The training method for the probability estimation network will be described in detail in the following text.

In addition, in some examples of the present disclosure, the entropy encoding may be any of the existing lossless compression encoding methods including but not limited to Huffman encoding, the arithmetic encoding, and Asymmetric Digital System (ANS) encoding. By one of these lossless compression encoding methods, the synonymous representation section ŷₛ may be compressed into the encoded sequence b and the compression efficiency limit of lossless compression encoding may be approached.

Furthermore, in some examples, when using a statistical method to estimate the probability of each quantized symbol in the synonymous representation section, in addition to the entropy encoding result of each quantized symbol in the synonymous representation section, it is also possible to further determine a codebook that carries information about the probability of each quantized symbol in the synonymous representation section, and add the codebook as necessary information in the encoded sequence b in front of entropy encoding results. That is, the codebook that carries information about the probability of each quantized symbol in the synonymous representation section can be placed at a starting position of the encoded sequence b to support an entropy decoding process at the decoding end. Specifically, the codebook may represent information that helps to determine a codeword corresponding to each quantized symbol. For example, when Huffman encoding is used, the codebook may refer to a mapping table between symbols to codewords. When the arithmetic encoding is used, the codebook may refer to probability interval partitioning rules. When ANS encoding is used, the codebook may refer to normalization tables of probability distributions.

In some other examples of the present disclosure, when a probability estimation method based on a neural network is used to estimate the probability of each quantized symbol in the synonymous representation section, in addition to the entropy encoding result of each quantized symbol in the synonymous representation section, side information carrying information about the probability of each quantized symbol in the synonymous representation section can be further determined, and the side information may be added in the encoded sequence b in front of the entropy encoding results as necessary information. That is, the side information carrying information about the probability of each quantized symbol in the synonymous representation section can be placed at a starting position of the encoded sequence b to support an entropy decoding process at the decoding end. In some examples, the side information may refer to auxiliary data transmitted from the encoding end to the decoding end carrying information about the probability of each quantized symbol in the synonymous representation section. For example, the side information may include contextual feature relationships, dynamically updated model states, or hyper-prior information, and etc. In other examples of the present disclosure, side information carrying information about the probability of each quantized symbol in the detailed representation section can be further determined, along with the side information carrying information about the probability of each quantized symbol in the synonymous representation section. Moreover, these two kinds of side information may be added in the encoded sequence b in front of the entropy encoding results as necessary information. The decoder at the decoding end will determine the probability of each quantized symbol in the detailed representation section in the encoded sequence b, and then obtain the detailed representation section in the reconstructed feature map through sampling based on the probability of each quantized symbol in the detailed representation section during the image reconstruction process. In this way, the reconstruction of the detailed representation section in the reconstructed feature map may be performed.

In some examples, existing context adaptive entropy encoding methods such as context adaptive Huffman encoding, arithmetic encoding, ANS encoding, etc. can also be utilized to encode the synonymous representation section. In this way, under a premise that the encoding end and the decoding end may have a same context probability transition pattern, the encoded sequence b can be obtained without using any probability estimation methods based on statistics or neural networks. In these examples, no additional information needs to be added at the starting position of the encoded sequence b to support the process of context adaptive entropy decoding at the decoding end.

It can be understood that the entropy encoding may be based on the information entropy theory. By analyzing a probability distribution of quantized symbols in the synonymous representation section, quantized symbols with high probability of occurrence may be encoded as shorter subsequences in the encoded sequence, and quantized symbols with low probability of occurrence may be encoded as longer subsequences in the encoded sequence. In this way, statistical redundancies between data may be reduced effectively. This compression method can significantly reduce an average code length, improve an overall compression efficiency, and approach a theoretical optimal compression limit.

As an alternative solution, in addition to the entropy encoding method mentioned above, other traditional source compression encoding methods can also be used to encode the synonymous representation section to obtain the encoded sequence b. It should be noted that the specific method of source compression encoding used in this disclosure is not limited.

It can be understood that after obtaining the encoded sequence, the encoding end can store the encoded sequence b to a storage medium or send it to a transmission port, so that it can be sent to the decoding end.

In examples of the present disclosure, the encoded sequence b may serve as a synonymous image compression result of the original image X (i.e. the image to be encoded), which can be stored in a storage medium so that the decoding end can call it as an input and use a method for synonymous image compression decoding provided in examples of the present disclosure to obtain a reconstructed image. In addition, it can also be transmitted to other terminal devices that can be used as the decoding end through the transmission port, using the Internet, a mobile communication network or any of other transmission media, so that the decoding end can obtain a reconstructed image by calling it as an input, and using a method for synonymous image compression decoding provided in examples of the present disclosure.

A main process of the method for synonymous image compression decoding can be summarized as follows: selecting a sample from a reconstructed synonymous set that is close to the ideal synonymous set as a reconstructed image based on the synonymous representation section of the image to be decoded by processes including detailed representation predictions, concatenations, comprehensive transformations and other steps. In this way, the reconstructed image with certain distortion constraints and certain perceptual similarity conditions with the original image (the image to be encoded in the encoding method) may be obtained.

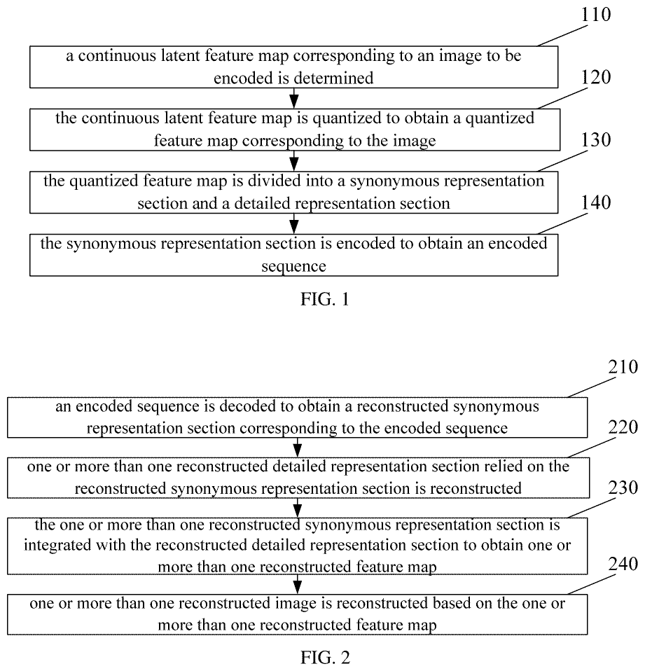

FIG. 2 is a flowchart of a method for synonymous image compression decoding according to an example of the present disclosure. As shown in FIG. 2, the method for synonymous image compression decoding may include the following steps.

In block 210, an encoded sequence is decoded to obtain a reconstructed synonymous representation section corresponding to the encoded sequence.

In some examples of the present disclosure, the decoder at the decoding end may retrieve the encoded sequence b from the storage medium or the transmission port as the input sequence for the image reconstruction process.

In addition, in examples of the present disclosure, the decoding operation performed by the decoder at the decoding end may correspond to the encoding operation performed by the encoder at the encoding end. That is to say, the decoder at the decoding end may use a decoding method corresponding to the encoding method used by the encoder at the encoding end to decode the encoded sequence.

In some examples of the present disclosure, if the encoder at the encoding end uses a traditional source compression encoding to encode the synonymous representation, then in block 210, the decoder at the decoding end may use the source compression decoding method corresponding to the source compression encoding to decode the encoded sequence. In this way, a reconstructed synonymous representation section corresponding to the encoded sequence may be obtained.

In some other examples of the present disclosure, the decoder at the decoding end may use an entropy decoding operation to decode the encoded sequence symbol by symbol, thereby obtaining the reconstructed synonymous representation section corresponding to the encoded sequence. Specifically, the entropy decoding operation can use a lossless compression decoding method corresponding to the entropy encoding operation used by the encoder at the encoding end, such as Huffman decoding, the arithmetic decoding, ANS decoding, and other decoding methods corresponding to Huffman encoding, the arithmetic encoding, ANS encoding, and etc. In this way, the encoded sequence b may be decoded into the reconstructed synonymous representation section.

In some examples of the present disclosure, the starting position of the encoding sequence b may include a codebook that carries information about the probability of each quantized symbol in the synonymous representation section. In this case, it is necessary to first decode the codebook included in the encoded sequence b, and based on the codebook decoded encoding, perform an entropy decoding on the sequence of the encoded sequence b except for the codebook, so as to recover the reconstructed synonymous representation section correctly through the entropy decoding operation.

In some other examples of the present disclosure, the encoded sequence b may include side information that carries information about the probability of each quantized symbol in the synonymous representation section at the starting position. In this case, it is necessary to first decode the side information that carries information about the probability of each quantized symbol in the synonymous representation section included in the encoded sequence b, so as to determine the probability of each quantized symbol in the synonymous representation section. Further, based on the probability of each quantized symbol in the synonymous representation section, an entropy decoding may be performed on the encoded sequence b except for the side information. In this way, the reconstructed synonymous representation may be recovered to correctly through the entropy decoding operation.

In block 220, one or more than one reconstructed detailed representation section relied on the reconstructed synonymous representation section is reconstructed.

In some examples of the present disclosure, a detailed reconstruction network that can perform a nonlinear transformation can be constructed based on a neural network including but not limited to a convolutional neural network (CNN), a recurrent neural network (RNN), or a transformer. The detailed reconstruction network may be used to predict the detailed representation section based on the reconstructed synonymous representation section input, and output one or more than one reconstructed detailed representation section relied on the reconstructed synonymous representation section. It should be noted that the training process of the detailed reconstruction network will be described below.

In some other examples, the one or more than one reconstructed detailed representation section corresponding to the encoded sequence may be reconstructed by sampling quantized symbols in a quantized symbols set. By sampling, the reconstruction of the detailed representation section may be achieved. In some specific examples, the sampling may be in a form of random sampling.

In some examples, if the encoded sequence further includes the side information carrying information about the probability of each quantized symbol in the detailed representation section, the side information may be decoded first, so as to determine the probability of each quantized symbol in the detailed representation section. Based on the probability of each quantized symbol in the detailed representation section, the quantized symbols in the quantized symbol set may be sampled to determine each quantized symbol included in the reconstructed detailed representation section. In this way, reconstruction of the one or more than one reconstructed detailed representation section may be realized.

As an example of sampling, a percentage of corresponding quantized symbol can be set based on the probability of each quantized symbol. Then, by generating a random number, the quantized symbol whose percentage corresponds to the generated random number may be determined as a sampling result. It should be noted that the sampling method is a symbol by symbol sampling method, which is only used as an example for illustration and not to limit the scope of the present disclosure. That is to say, any of other sampling methods can also be used in the disclosed examples.

In block 230, the one or more than one reconstructed synonymous representation section is integrated with the reconstructed detailed representation section to obtain one or more than one reconstructed feature map.

In some examples, the way of integrating the reconstructed synonymous representation section with the one or more than one reconstructed detailed representation section at the decoding end may corresponds to the way of dividing the quantized feature map into the synonymous representation section and the detailed representation section at the encoding end. Specifically, the way of integrating the reconstructed synonymous representation with the one or more than one reconstructed detailed representation section at the decoding end may be the same as the way of dividing the quantized feature map into the synonymous representation section and the detailed representation section at the encoding end.

It should be noted that when the number of reconstructed detailed representation portions section is more than one, for example, the number is N, the reconstructed synonymous representation section can be copied to obtain N reconstructed synonymous representation sections. That is, the number of reconstructed synonymous representation sections obtained through copying may be the same as the number of reconstructed detailed representation sections. Then, each reconstructed synonymous representation section may be integrated with a reconstructed detailed representation section separately. In this way, N reconstructed feature maps would be obtained in total.

In block 240, one or more than one reconstructed image is reconstructed based on the one or more than one reconstructed feature map.

In some examples of the present disclosure, a synthesis transform on the reconstructed feature map may be performed to obtain the reconstructed images.

In some examples, the synthesis transform may be understood as a non-linear transformation. Assuming that the synthesis transform is represented by gₛ(·), the synthesis transform of a reconstructed feature map described in block 240 can be expressed as: \tilde{x}=gₛ(\tilde{y}). Among them, \tilde{y} represents the reconstructed feature map; \tilde{x} represents the reconstructed image. It can be understood that the synthesis transform gₛ(·) should have an ability to transform the reconstructed feature map \tilde{y} into the reconstructed image \tilde{x}.

In some examples, the synthesis transform can also be built based on a neural network including but not limited to a convolutional neural network (CNN), a recurrent neural network (RNN), or a transformer, to construct a synthesis transform network that can achieve the nonlinear transformation. It can be understood that the synthesis transform network may contain trainable parameters, and the parameters can be optimized through the training method provided in some examples of the present disclosure, so that the synthesis transform network trained may have the ability to transform the reconstructed feature map \tilde{y} into the reconstructed image \tilde{x}. The training method for the synthesis transform network will be described in detail in the following.

It should be noted that when the number of the reconstructed feature maps \tilde{y} is more than one, for each reconstructed feature map \tilde{y}, a corresponding reconstructed image \tilde{x} may be obtained through the synthesis transform gₛ(·). Then the method may further include integrating the multiple reconstructed images \tilde{x} into a reconstructed synonymous set [symbol] .

Based on the method for synonymous image compression encoding, the synonymous image compression can be applied to an image with specific average distortion constraints and specific average perceptual loss constraints. In addition, through the method for synonymous image compression decoding, one or more than one reconstructed image with certain reconstruction distortions and certain perceptual loss can be obtained. Through the above schemes an efficient and accurate image compression can be achieved, and the efficiency of image data transmission in the Internet can be improved.

According to the method for synonymous image compression encoding and the method for synonymous image compression decoding, examples of the present disclosure also propose an optimized joint training of the analysis transform network and the synthesis transform network. In some examples, for the sake of convenience in descriptions, a system framework constructed by the analysis transform network and the synthesis transform network may be referred to as a synonymous image compression model as a whole. The synonymous image compression model may also be referred to as an encoder-decoder model. Accordingly, the method of training the synonymous image compression model may also be referred to as the method for encoder-decoder model training. It should be noted that if in some examples, the method for synonymous image compression encoding uses a probability estimation network, or the method for synonymous image compression decoding uses a detail reconstruction network, then the probability estimation network and/or the detail reconstruction network can also be regarded as a part of the encoder-decoder model and can be trained together during the training process of the encoder-decoder model.

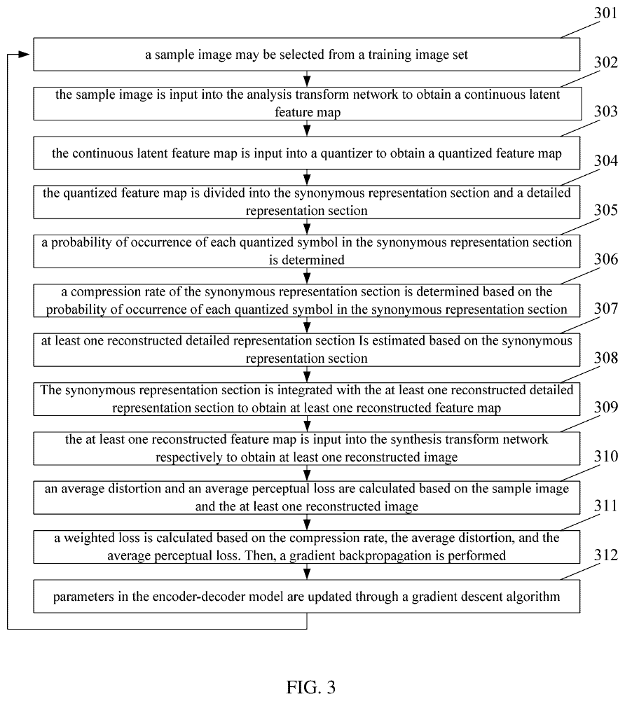

FIG. 3 is a flowchart of a method for encoder-decoder model training according to an example of the present disclosure. The training method shown in FIG. 3 may use sample images in a training dataset to form training batches, generate one or more reconstructed images for each sample image, establish a loss function based on the sample images and the reconstructed images, and use a gradient descent to optimize the training of the encoder-decoder model.

Specifically, as shown in FIG. 3, the method for encoder-decoder model training can include the following steps.

In block 301, a sample image may be selected from a training dataset.

In some examples of the present disclosure, it is allowed to select multiple sample images from the training dataset at once for gradient feedback and parameter updates in a single round of model training.

In block 302, the sample image is input into the analysis transform network to obtain a continuous latent feature map.

To be noted, the step in block 302 can be implemented by the method disclosed and will not be repeated here.

In block 303, the continuous latent feature map is input into a quantizer to obtain a quantized feature map.

As mentioned above, in some examples, the quantizer may quantize the continuous latent feature map based on pre-set quantization levels. In other examples, the quantizer may also use a rounding quantization to quantize the continuous latent feature map.

In addition, to support the gradient backpropagation during the training process, the quantizer should retain the gradient backpropagation capability when processing the continuous latent feature map. Moreover, to achieve an effective training of parameters, any existing model training technique for quantization may be used. For example, in some examples, during the gradient backpropagation process, the quantizer may directly assign gradient information at the quantized feature map to the continuous latent feature map. In other examples, the quantizer may obtain a noisy feature map by superimposing a sampling sequence from unit uniform noise on the continuous latent feature map, and use the noisy feature map as the quantized feature map. In examples of the present disclosure, by utilizing the quantization methods described in previous examples, the quantizer can quantize the continuous latent feature map into the quantized feature map.

In block 304, a synonymous representation section is determined in the quantized feature map, and the quantized feature map is divided into the synonymous representation section and a detailed representation section.

To be noted, the step in block 304 can be implemented by the method disclosed above and will not be repeated here.

In block 305, a probability of each quantized symbol in the synonymous representation section is determined.

In some examples, assuming the quantizer adopts a quantization method based on pre-set quantization levels, the probability of each quantized symbol in the synonymous representation section can be estimated statistically. For example, the frequency of each quantized symbol shown in the synonymous representation section can be used as the probability of each quantized symbol in the synonymous representation section.

In other examples, assuming that the quantizer adopts the rounding quantization and each quantized symbol follows a Gaussian distribution with specific distribution characteristics, a probability estimation method based on a neural network can be used to obtain distribution characteristics of each quantized symbol ŷᵢ in the synonymous representation section ŷₛ, including a mean μᵢ and a standard deviation σᵢ. Then the distribution characteristics of each quantized symbol ŷᵢ in the synonymous representation section ŷₛ may be used to determine the probability of each quantized symbol \grave{y}ᵢ in the synonymous representation section ŷₛ. For example, in some examples, the probability of occurrence p(ŷᵢ) of each quantized symbol ŷᵢ in the synonymous representation section ŷₛ can be determined by the following expression.

$$p ( {\hat{y}}_{i} ) = {\int }_{{\hat{y}}_{i} - \frac{1}{2}}^{{\hat{y}}_{i} + \frac{1}{2}} \frac{1}{\sqrt{2 π} {σ}_{i}} exp ( - \frac{{( y - {u}_{i} )}^{2}}{2 {σ}_{i}^{2}} ) dy$$

In block 306, a compression rate of the synonymous representation section is determined based on the probability of each quantized symbol in the synonymous representation section.

In some examples, the compression rate R(ŷₛ) of the synonymous representation section can be calculated based on the probability of occurrence p(ŷᵢ) of each quantized symbol ŷᵢ in the synonymous representation section ŷₛ. For example, in some examples, the compression rate R(ŷₛ) of the synonymous representation section can be determined by the following expression.

$$R ( {\hat{y}}_{s} ) = - {\sum }_{i = 1}^{n} log p ( {\hat{y}}_{i} )$$

Where, n refers to the number of quantized symbols in the synonymous representation section ŷₛ.

In block 307, at least one reconstructed detailed representation section is estimated based on the synonymous representation section.

In block 308, the synonymous representation section is integrated with the at least one reconstructed detailed representation section to obtain at least one reconstructed feature map.

In block 309, the at least one reconstructed feature map is input into the synthesis transform network respectively to obtain at least one reconstructed image.

The steps in blocks 307-309 may be implemented by methods disclosed in previous examples and will not be repeated here.

In block 310, an average distortion and an average perceptual loss are calculated based on the sample image and the at least one reconstructed image.

In some examples, when there is only one reconstructed image, the average distortion may be determined by the distortion metric function d(·). That is, the distortion metric d(x,\tilde{x}) between the sample image x and the reconstructed image \tilde{x} may be calculated and regarded as the average distortion. In addition, when there is only one reconstructed image, the average perceptual loss may be determined by the perceptual loss metric function dₚ(·). That is, the perceptual loss dₚ(pₓ,p_{\tilde{x}}) between the sample image x and the reconstructed image \tilde{x} may be calculated and regarded as the average perceptual loss.

In some other examples of the present disclosure, when there are multiple reconstructed images, the average distortion may be determined by the following steps: for each of the multiple reconstructed images \tilde{x}ⱼ, calculating a distortion matric between the sample image x and the reconstructed image \tilde{x}ⱼ to obtain multiple distortion matrices, and calculating the average of the multiple distortion matrices [symbol] _{\tilde{x}}_{ⱼ}_{∈}x[d(x,\tilde{x}ⱼ)] as the average distortion. Further, the average perceptual loss may be determined by the following steps: for each of the multiple reconstructed image \tilde{x}ⱼ, calculating a perceptual loss between the sample image x and the reconstructed image \tilde{x}ⱼ to obtain multiple perceptual losses, and calculating the average of the multiple perceptual losses [symbol] _{\tilde{x}}_{ⱼ}_{∈}x[dₚ(pₓ,p_{\tilde{x}}_{ⱼ})] as the average perceptual loss.

For convenience of expression, the case where there is only one reconstructed image is taken as a special case where there are multiple reconstructed images. Therefore, in the following, [symbol] _{\tilde{x}}_{ⱼ}_{∈}\tilde{x}[d(x,\tilde{x}ⱼ)] will be used to represent the average distortion, and [symbol] _{\tilde{x}}_{ⱼ}_{∈}\tilde{x}[dₚ(pₓ,p_{\tilde{x}}_{ⱼ})] will be used to represent the average perceptual loss.

In specific applications, the distortion metric function can be implemented by one of the mean square error function (MSE), multi-scale structural similarity function (MS-SSIM), and etc. The perceptual loss metric function can be implemented by divergence calculation methods such as KL divergence, Wasserstein divergence, JS divergence, or using perception indicators that are close to perception quality, such as learned perceptual image patch similarity (LPIPS) and depth image structure and texture similarity index (DISTS).

In block 311, a weighted loss is calculated based on the compression rate, the average distortion, and the average perceptual loss. Then, a gradient backpropagation is performed.

In some examples of the present disclosure, the weighted loss may be determined based on the following expression:

[symbol]

ₓ=λ_{d}· [symbol] _{\tilde{x}}_{ⱼ}_{∈}\tilde{x}[d(x,\tilde{x}ⱼ)]+λₚ· [symbol] _{\tilde{x}}_{ⱼ}_{∈}\tilde{x}[dₚ(pₓ,p_{\tilde{x}}_{ⱼ})]+λᵣ·R(ŷₛ)

Wherein, λ_{d} represents a weighted coefficient of the average distortion; λₚ represents a weighted coefficient of the average perceptual loss; λᵣ represents a weighted coefficient of the compression rate; and R(ŷₛ) represents the compression rate.

In some examples of the present disclosure, the quantized feature map may be separated into L sets of quantized representation portions, that is, the quantized feature map may be divided into L synonymous levels. In this case, a weighted loss of each synonymous level may be determined first; and then the weighted loss may be determined according to each weighted loss of each synonymous level.

Specifically, a weighted loss of a |^{th} synonymous level may be determined based on the following expression:

[symbol]

x^{(l)}=λ_{d}^{(l)}· [symbol] _{\tilde{x}}_{ⱼ}_{∈}\tilde{x}[d(x,\tilde{x}ⱼ)]+λ_{d}^{(l)}· [symbol] _{\tilde{x}}_{ⱼ}_{∈}\tilde{x}[dₚ(pₓ,p_{\tilde{x}}_{ⱼ})]+λᵣ^{(l)}·R(ŷₛ)

Wherein, λ_{d}^{(l)} represents a weighted coefficient of an average distortion of the |^{th} synonymous level; λₚ^{(l)} represents a weighted coefficient of an average perceptual loss of the |^{th} synonymous level; λᵣ^{(l)} represents a weighted coefficient of a compression rate of the |^{th} synonymous level; and R(ŷₛ) represents the compression rate.

Moreover, the weighted loss may be determined based on the following expression:

[symbol]

ₓ=α⁽¹⁾· [symbol] ₓ⁽¹⁾+α⁽²⁾· [symbol] ₓ⁽²⁾+ . . . +α^{(L)}· [symbol] ₓ^{(L)}

Where, α⁽¹⁾,α⁽²⁾, . . . α^{(L)} represent weight coefficients corresponding to each synonymous level 1, 2, . . . , L, respectively; and for each l, α^{(l)}≥0.

In block 312, parameters in the encoder-decoder model are updated through a gradient descent algorithm.

In some examples, the gradient descent algorithm may include but is not limited to any of the stochastic gradient descent algorithm, the Adam algorithm, and etc.

Next, the training process will be iterated until the weighted loss converges or the required number of iterations is reached. After the training process is complete, a final encoder-decoder model can be obtained. That is, parameters of all network structures of the analysis transform network and synthesis transform network can be obtained. When the encoder-decoder model also includes a probability estimation network and/or a detail reconstruction network, parameters of all network structures of the probability estimation network and/or the detail reconstruction network can also be obtained through the training process.

It can be seen that through the training method, the analysis transform network at the encoding end can be trained, which can be used to implement the method for synonymous image compression encoding disclosed. Therefore, a synonymous image compression of an image can be achieved. In addition, through the training method, the synthesis transform network at the decoding end can also be trained, which can be used to implement the method for synonymous image compression decoding disclosed. Therefore, a reconstructed image with a certain reconstruction distortion and a certain perceptual loss may be obtained.

In addition, it can be seen that the weighted loss may be determined based on a compression rate, an average distortion, and an average perceptual loss. This may establish an optimization direction for image compression that balances the compression rate, the average distortion, and the average perceptual loss. As a result, the encoder-decoder model obtained through the training process can achieve a synonymous compression encoding of an image at the encoding end, while ensuring the efficiency of image compression and obtaining a reconstructed image with a certain distortion and a certain perceptual similarity with the image at the decoding end.

In order to verify the effectiveness of the method for synonymous image compression encoding and the method for synonymous image compression decoding described in examples of the present disclosure, comparative experiments were conducted on different image compression methods. A training dataset used for training the encoder-decoder model may include 100000 natural images selected from a publicly available dataset Open Images v6. These 100000 natural images may be cropped randomly to adjust a resolution of an input image for model training to 256*256. The publicly available CLIC2020 test dataset may be taken as a test dataset and the DIV2K validation dataset may be taken as a validation dataset. In addition, the encoder-decoder model may adopt a multi-level synonymous encoding framework, where the number of synonymous levels L is set to 16. In the loss function, the distortion metric function d(·) adopts the mean square error function, and the perceptual loss metric function dₚ(·) adopts the learned perceptual image patch similarity (LPIPS). During the training process, an iteration counts is set to 1×10⁶ times, a batch size is set to 16, the AdamW optimizer for training is adopted, a learning rate is set to 1×10⁻⁴, and the weight decay rate is set to 5×10⁻⁵. During the testing process, in order to approximate the subjective evaluation of human perception quality, the Deep Image Structure and Texture Similarity Index (DISTS) may be selected to evaluate the perceptual quality of the reconstructed image.

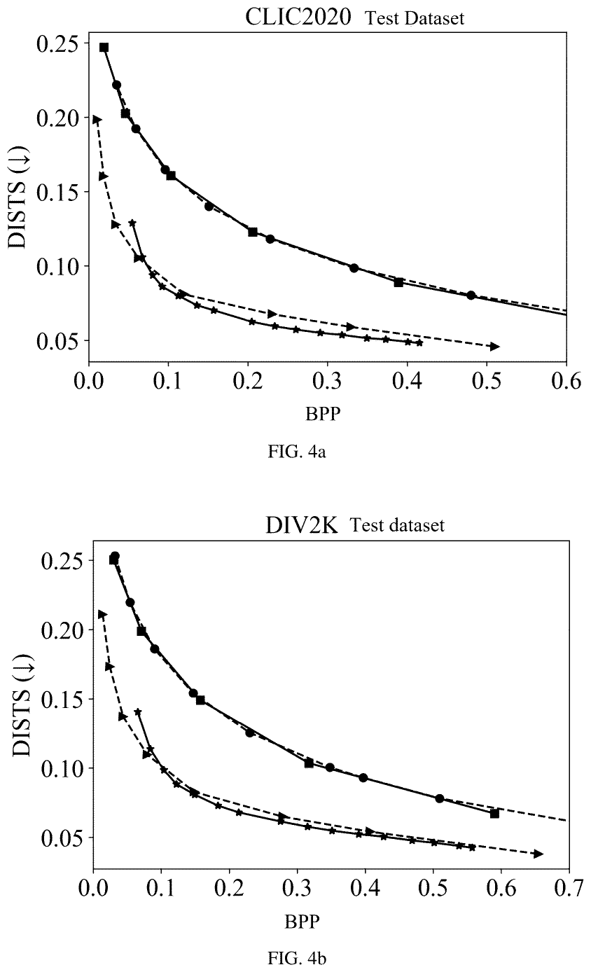

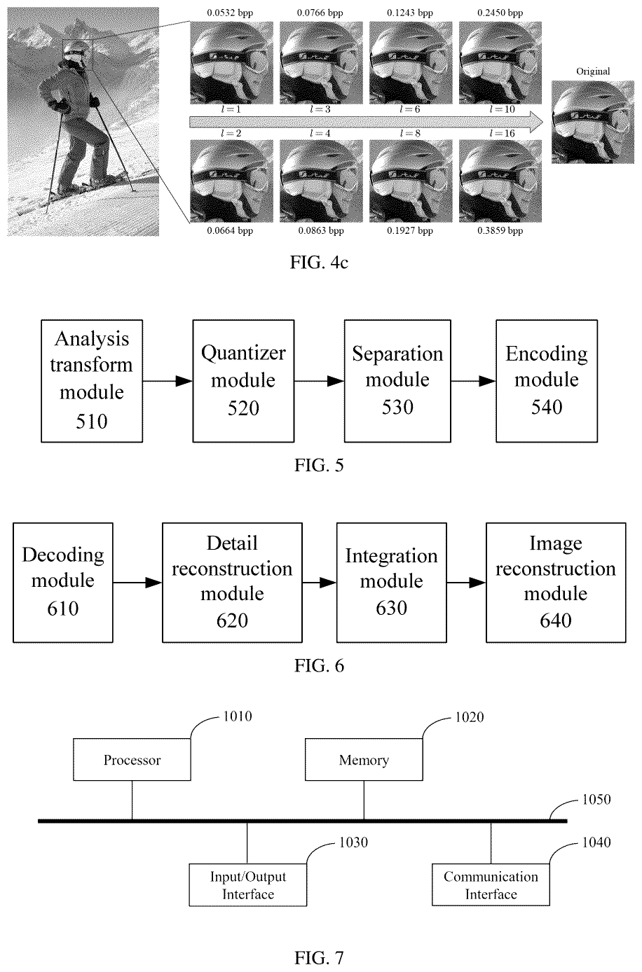

FIG. 4a and FIG. 4b illustrate perceptual quality curves at different compression rates corresponding to the method for synonymous image compression encoding, the method for synonymous image compression decoding, and traditional image compression schemes according to some examples of the present disclosure. FIG. 4a may correspond to the CLIC2020 test dataset. FIG. 4b may correspond to the DIV2K validation dataset. In FIG. 4a and FIG. 4b, solid lines with asterisks may be used to represent the perceptual quality curves at different compression rates corresponding to method for the synonymous image compression encoding and the method for the synonymous image compression decoding disclosed. The comparison schemes include the traditional image compression scheme BPG (represented by dashed lines with dots), VTM (represented by solid lines with squares), and the existing perceptual image compression scheme MS-ILLM (No Gan) (represented by dashed lines with triangles). Among them, the horizontal axis represents the compression rate, expressed in bits per pixel (BPP); and the vertical axis represents DISTS. The experimental results show that comparing not only with traditional image compression methods but also existing perceptual image compression methods, the method for synonymous image compression encoding and decoding described in examples of the present disclosure may have certain advantages in perceptual quality. When the bits per pixel (BPP) representing the compression rate is greater than 0.1, the method disclosed in present disclosure can achieve a compression rate improvement of 0.05~0.1 BPP at a same perceptual quality. That is to say, experimental data shows that the method for synonymous image compression encoding and decoding proposed can improve the compression efficiency of images effectively while ensuring the quality of reconstructed images.

In addition, by comparing the reconstructed images at different synonymous levels through experiments, the reconstructed images at different synonymous levels corresponding to the method for synonymous image compression encoding and the method for synonymous image compression decoding according to some examples of the present disclosure are shown in FIG. 4c. It can be seen from FIG. 4c that reconstructed images with different perceptual qualities can be obtained. Among them, when the synonymous level |=1 (i.e. a lowest synonymous level), a reconstructed image with a high perceptual similarity to the original image can be obtained, but textual details are not so clear, indicating that a lower synonymous level may focus on perceptual similarity of the global image. As the synonymous level increases gradually, the reconstructed image becomes more similar to the original image, and the textual details become clearer. This indicates that the higher the synonymous level is, the more attention may be paid to the perceptual similarity of detailed contents. Meanwhile, it can also be seen from FIG. 4c that the lower the synonym level is, the lower the corresponding BPP is.

Corresponding to the method for synonymous image compression encoding and the method for synonymous image compression decoding, the present disclosure also provides a synonymous image compression encoder that implements the method for synonymous image compression encoding and a synonymous image compression decoder that implements the method for synonymous image compression decoding.

FIG. 5 shows a specific structure of the synonymous image compression encoder according to examples of the present disclosure. As shown in FIG. 5, the synonymous image compression encoder may include the following modules.

An analysis transform module 510, configured to determine a continuous latent feature map corresponding to an image to be encoded.

A quantizer 520, configured to quantize the continuous latent feature map and obtain a quantized feature map corresponding to the image to be encoded.

A separation module 530, configured to divide the quantized feature map into a synonymous representation section and a detailed representation section.

An encoding module 540, configured to encode the synonymous representation section to obtain an encoded sequence.

In some examples of the present disclosure, the continuous latent feature map output by the analysis transform module 510 may be divided into a continuous synonymous representation portion and a continuous detailed representation portion. In this case, the quantizer 520 may quantize the continuous synonymous representation portion to obtain a quantized synonymous representation portion and quantize the continuous detailed representation portion to obtain a quantized detailed representation portion. Therefore, the separation module 530 may take the quantized synonymous representation portion as the synonymous representation section and take the quantized detailed representation portion as the detailed representation section.

In some other examples of the present disclosure, the continuous latent feature map output by the analysis transform module 510 may have L sets of continuous representation portions. At Accordingly, the quantized feature map output by the quantizer 520 may include L sets of quantized representation portions. Moreover, based on degrees of importance, the L sets of quantized representation portions may be sorted from a high degree of importance to a low degree of importance as ŷ^{(l)},l=1, 2, . . . ,L. Based on this, the separation module 330 may pre-set a value of M and select a first M sets of quantized representation portions

$${\hat{y}}_{s}^{( M )}$$

as the synonymous representation section ŷₛ corresponding to the synonymous level M, and take the un-selected sets of quantized representation portions

$${\hat{y}}_{ε}^{( M )}$$

as the detailed representation section ŷ_{ε}.

Alternatively, the continuous latent feature map output by the analysis transform module 510 may have L sets of continuous representation portions. At Accordingly, the quantized feature map output by the quantizer 520 may include L sets of quantized representation portions. Moreover, based on degrees of importance, the L sets of quantized representation may be sorted from a low degree of importance to a high degree of importance as y̅^{(l)},l=1, 2, . . . ,L. Based on this, the separation module 330 may pre-set a value of M and select a last L−M+1 sets of quantized representation portions

$${\hat{y}}_{s}^{( M )}$$

as the synonymous representation section ŷₛ corresponding to the synonymous level M, and take the un-selected sets of quantized representation portions

$${\hat{y}}_{ε}^{( M )}$$

as the detailed representation section ŷ_{ε}.

FIG. 6 shows a specific structure of the synonymous image compression decoder according to examples of the present disclosure. As shown in FIG. 6, the synonymous image compression decoder may include the following modules.

A decoding module 610, configured to decode an encoded sequence to obtain a reconstructed synonymous representation section corresponding to the encoded sequence.

A detail reconstruction module 620, configure to reconstruct one or more than one reconstructed detailed representation section relied on the reconstructed synonymous representation section.

An integration module 630, configured to integrate the reconstructed synonymous representation section with one or more than one reconstructed detailed representation section to obtain one or more than one reconstructed feature map.

An image reconstruction module 640, configured to reconstruct one or more than one reconstructed image based on one or more than one reconstructed feature map.

It should be noted that implementations and specific technical effects of each module in the device can refer to implementation of steps in previous examples, and will not be repeated here.

Based on the synonymous image compression encoder, a method for synonymous image compression encoding can be performed on an image with specific average distortion constraints and specific average perceptual loss constraints. In addition, based on the synonymous image compression decoder, a reconstructed image with a certain reconstruction distortion and a certain perceptual loss can be obtained. The above scheme can achieve an efficient and accurate image compression, and improve the efficiency of image transmissions in the Internet.

Based on a same inventive concept and corresponding to examples of the present disclosure, the present disclosure also provides an electronic device comprising: a memory, a processor, and a computer program stored on the memory and executable on the processor. When the processor executes the computer program, it implements the method for image synonymous image compression encoding or decoding disclosed.

FIG. 7 illustrates a more detailed hardware structure diagram of an electronic device according to this example. The device may include: a processor 1010, a memory 1020, an input/output interface 1030, a communication interface 1040, and a bus 1050. The processor 1010, memory 1020, input/output interface 1030, and communication interface 1040 are communicatively connected within the device via the bus 1050.

The processor 1010 may be implemented using a general-purpose CPU (Central Processing Unit), microprocessor, ASIC (Application-Specific Integrated Circuit), or one or more integrated circuits. It is configured to execute related programs to implement the technical solutions provided in the examples of the present specification.

The memory 1020 may be implemented using ROM (Read-Only Memory), RAM (Random Access Memory), static storage devices, or dynamic storage devices. The memory 1020 stores operating systems and other applications. When implementing the technical solutions of the examples of the present specification via software or firmware, related program codes are stored in the memory 1020 and invoked by the processor 1010 for execution.

The input/output interface 1030 is connected to an input/output module to enable information input and output. The input/output module may be integrated into the device (not shown) or externally connected to provide corresponding functions. Input devices may include keyboards, mice, touchscreens, microphones, and various sensors. Output devices may include displays, speakers, vibrators, and indicator lights.

The communication interface 1040 is connected to a communication module (not shown) to enable communication between the device and other devices. The communication module may use wired methods (e.g., USB, network cables) or wireless methods (e.g., mobile networks, Wi-Fi, Bluetooth).

The bus 1050 provides a pathway for transmitting information among components (e.g., processor 1010, memory 1020, input/output interface 1030, and communication interface 1040) of the device.

It should be noted that although the above device illustrates only the processor 1010, memory 1020, input/output interface 1030, communication interface 1040, and bus 1050, additional components necessary for normal operation may be included in practical implementations. Furthermore, those skilled in the art will understand that the device may include only components necessary for implementing the solutions of the examples of the present specification and need not include all components shown in the figure.

The electronic device in the above examples is used to implement the corresponding method for image synonymous image compression encoding or decoding in any of the preceding examples and has the beneficial effects of the corresponding method, which are not repeated here.

Based on the same inventive concept and corresponding to any of the above method, the present disclosure further provides a non-transitory computer-readable storage medium storing computer instructions. The computer instructions are configured to cause a computer to execute the method for image synonymous image compression encoding or decoding as described in any of the preceding examples.

The computer-readable medium in this example includes permanent and non-permanent, removable and non-removable media implemented by any method or technology for information storage. The information may be computer-readable instructions, data structures, program modules, or other data. Examples of computer storage media include, but are not limited to: phase-change memory (PRAM), static random-access memory (SRAM), dynamic random-access memory (DRAM), other types of RAM, read-only memory (ROM), electrically erasable programmable read-only memory (EEPROM), flash memory, other memory technologies, CD-ROM, DVD, other optical storage, magnetic cassettes, magnetic tape storage, other magnetic storage devices, or any other non-transitory media capable of storing information accessible to computing devices.

The storage medium in the above examples stores computer instructions for causing a computer to execute the method for image synonymous image compression encoding or decoding as described in any of the preceding examples, with the beneficial effects of the corresponding method, which are not repeated here.

Those skilled in the art should understand that the discussion of the above examples is exemplary and not intended to imply that the scope of the present disclosure (including the claims) is limited to these examples. Under the principles of the present disclosure, the technical features in the above examples or different examples may be combined, steps may be executed in any order, and many other variations exist as described in the different aspects of the examples of the present disclosure, which are not detailed for brevity.

Additionally, to simplify explanation and discussion and to avoid obscuring the examples of the present disclosure, known power/ground connections to integrated circuit (IC) chips and other components may or may not be shown in the provided figures. Furthermore, devices may be illustrated in block diagram form to avoid obscuring the examples, considering that implementation details of such block diagrams are highly platform-dependent (i.e., these details should be fully understandable to those skilled in the art). When specific details (e.g., circuits) are provided to describe exemplary examples of the present disclosure, it will be apparent to those skilled in the art that the examples may be practiced without these details or with modifications thereto. Thus, the descriptions are to be regarded as illustrative rather than restrictive.

Although the present disclosure has been described with reference to specific examples, many alternatives, modifications, and variations will be apparent to those skilled in the art based on the foregoing description. For example, other memory architectures (e.g., dynamic RAM (DRAM)) may be used in the discussed examples.

The examples of the present disclosure are intended to cover all such alternatives, modifications, and variations falling within the broad scope of the appended claims. Therefore, any omissions, modifications, equivalent substitutions, or improvements made within the spirit and principles of the examples of the present disclosure shall be included within the scope of protection of the present disclosure.

What is claimed is:

1. A method for synonymous image compression encoding, comprising:
determining a continuous latent feature map corresponding to an image to be encoded;
quantizing the continuous latent feature map to obtain a quantized feature map corresponding to the image;
dividing the quantized feature map into a synonymous representation section and a detailed representation section; and
encoding the synonymous representation section to obtain an encoded sequence.

2. The method according to claim 1, wherein, determining the continuous latent feature map corresponding to the image to be encoded comprises:
using the image as an input to an analysis transform network;
performing an analysis transform on the image by the analysis transform network; and
outputting the continuous latent feature map corresponding to the image by the analysis transform network.

3. The method according to claim 1, wherein, quantizing the continuous latent feature map to obtain the quantized feature map corresponding to the image comprises:
for each symbol in the continuous latent feature map, quantizing the symbol to a predetermined quantization level closest to a value of the symbol to obtain a quantized symbol corresponding to the symbol; and
sorting quantized symbols obtained according to an arrangement order of the symbols in the continuous latent feature map to obtain the quantized feature map.

4. The method according to claim 1, wherein, the continuous latent feature map comprises: a continuous synonymous representation portion and a continuous detailed representation portion;
quantizing the continuous latent feature map to obtain a quantized feature map corresponding to the image comprises: quantizing the continuous synonymous representation portion to obtain a quantized synonymous representation portion, and quantizing the continuous detailed representation portion to obtain a quantized detailed representation portion; and
dividing the quantized feature map into a synonymous representation section and a detailed representation section comprises: taking the quantized synonymous representation portion as the synonymous representation section; and taking the quantized detailed representation portion as the detailed representation section.

5. The method according to claim 1, wherein, the continuous latent feature map comprises: L sets of continuous representation portions corresponding to L synonymous levels; where, L is a positive integer;
the quantized feature map comprises: L sets of quantized representation portions corresponding to L synonymous levels;
wherein dividing the quantized feature map into the synonymous representation section and the detailed representation section comprises:
arranging the L sets of quantized representation portions from a high degree of importance to a low degree of importance;
selecting a first M sets of quantized representation portions as the synonymous representation section; wherein, M is a pre-set positive integer and is less than or equal to L; and
taking un-selected sets of quantized representation portions as the detailed representation section.

6. The method according to claim 1, wherein, the continuous latent feature map comprises: L sets of continuous representation portions corresponding to L synonymous levels; where, L is a positive integer;
the quantized feature map comprises: L sets of quantized representation portions corresponding to L synonymous levels;
wherein dividing the quantized feature map into the synonymous representation section and the detailed representation section comprises:
arranging the L sets of quantized representation portions from a low degree of importance to a high degree of importance;
selecting a last L−M+1 sets of quantized representation portions as the synonymous representation section; wherein, M is a pre-set positive integer and is less than or equal to L; and
taking un-selected sets of quantized representation portions as the detailed representation section.

7. The method according to claim 1, further comprising:
transforming the continuous latent feature map from a latent domain to a frequency domain to obtain a frequency domain feature map;
dividing the frequency domain feature map into a synonymous frequency domain portion and a detailed frequency domain portion based on a pre-set frequency threshold;
transforming the synonymous frequency domain portion from the frequency domain to the latent domain to obtain a continuous synonymous representation portion; and
transforming the detailed frequency domain portion from the frequency domain to the latent domain to obtain a continuous detailed representation portion;
quantizing the continuous latent feature map to obtain a quantized feature map corresponding to the image comprises: quantizing the continuous synonymous representation portion to obtain a quantized synonymous representation portion, and quantizing the continuous detailed representation portion to obtain a quantized detailed representation portion; and
dividing the quantized feature map into a synonymous representation section and a detailed representation section comprises: taking the quantized synonymous representation portion as the synonymous representation section; and taking the quantized detailed representation portion as the detailed representation section.

8. The method according to claim 1, wherein, encoding the synonymous representation section to obtain the encoded sequence comprises:
estimating a probability of each quantized symbol in the synonymous representation section; and
performing an entropy encoding on the synonymous representation section based on the probability of each quantized symbol in the synonymous representation section to obtain the encoded sequence.

9. The method according to claim 8, wherein, the encoded sequence comprises: an encoding codebook carrying information about the probability of each quantized symbol in the synonymous representation section, or side information carrying information about the probability of each quantized symbol in the synonymous representation section.

10. A method for synonymous image compression decoding, comprising:
decoding an encoded sequence to obtain a reconstructed synonymous representation section corresponding to the encoded sequence;
reconstructing one or more than one reconstructed detailed representation section relied on the reconstructed synonymous representation section;
integrating the reconstructed synonymous representation section with the one or more than one reconstructed detailed representation section to obtain one or more than one reconstructed feature map; and
reconstructing one or more than one reconstructed image based on the one or more than one reconstructed feature map.

11. The method according to claim 10, wherein, decoding the encoded sequence to obtain the reconstructed synonymous representation section corresponding to the encoded sequence comprises:
performing an entropy decoding on the encoded sequence to obtain the reconstructed synonymous representation section.

12. The method according to claim 10, wherein, reconstructing one or more than one reconstructed detailed representation section relied on the reconstructed synonymous representation section comprises:
using the reconstructed synonymous representation section as an input to a detail reconstruction network;
predicting the one or more than one reconstructed detailed representation section by the detail reconstruction network; and
outputting the one or more than one reconstructed detailed representation section relied on the reconstructed synonymous representation section by the detail reconstruction network.

13. The method according to claim 10, wherein, reconstructing one or more than one reconstructed detailed representation section relied on the reconstructed synonymous representation section comprises:
sampling quantized symbols in a quantized symbol set to determine each quantized symbol included in the one or more than one reconstructed detailed representation section.

14. The method according to claim 10, wherein, reconstructing one or more than one reconstructed image based on the one or more than one reconstructed feature map comprises:
using the one or more than one reconstructed feature map as an input to a synthesis transform network;
performing a synthesis transform on the one or more than one reconstructed feature map by the synthesis transform network; and
outputting the one or more than one reconstructed image by the synthesis transform network.

15. A method for encoder-decoder model training, wherein, the encoder-decoder model comprises: an analysis transform network and a synthesis transform network;
wherein the method for encoder-decoder model training comprises:
selecting a sample image from a training dataset;
inputting the sample image into the analysis transform network to obtain a continuous latent feature map;
inputting the continuous latent feature map into a quantizer to obtain a quantized feature map;
dividing the quantized feature map into a synonymous representation section and a detailed representation section;
determining a probability of each quantized symbol in the synonymous representation section;
determining a compression rate of the synonymous representation section based on the probability of each quantized symbol in the synonymous representation section;
estimating at least one reconstructed detailed representation based on the synonymous representation section;
integrating the synonymous representation section with the at least one reconstructed detailed representation section to obtain at least one reconstructed feature map;
inputting the at least one reconstructed feature map into the synthesis transform network respectively to obtain at least one reconstructed image;
calculating an average distortion and an average perceptual loss based on the sample image and the at least one reconstructed image;
calculating a weighted loss based on the compression rate, the average distortion, and the average perceptual loss;
performing a gradient backpropagation; and
using a gradient descent algorithm to update parameters in the encoder-decoder model.

16. The method according to claim 15, wherein, calculating the average distortion and the average perceptual loss based on the sample image and the at least one reconstructed image comprises:
calculating the average distortion [symbol] _{\tilde{x}}_{ⱼ}_{∈}\tilde{x}[d(x,\tilde{x}ⱼ)] between the sample image x and each of the at least one reconstructed image \tilde{x}ⱼ as the average distortion; and
calculating the average perceptual loss [symbol] _{\tilde{x}}_{ⱼ}_{∈}\tilde{x}[dₚ(pₓ,p_{\tilde{x}}_{ⱼ})] between the sample image x and each of the at least one reconstructed image \tilde{x}ⱼ as the average perceptual loss.

17. The method according to claim 15, wherein, calculating the weighted loss based on the compression rate, the average distortion, and the average perceptual loss comprises:
determining the weighted loss based on the following expression: [symbol]
ₓ=λ_{d}· [symbol] _{\tilde{x}}_{ⱼ}_{∈}\tilde{x}[d(x,\tilde{x}ⱼ)]+λₚ· [symbol] _{\tilde{x}}_{ⱼ}_{∈}\tilde{x}[dₚ(pₓ,p_{\tilde{x}}_{ⱼ})]+λᵣ·R(ŷₛ)
wherein, λ_{d} represents a weighted coefficient of the average distortion; λₚ represents a weighted coefficient of the average perceptual loss; λᵣ represents a weighted coefficient of the compression rate; and R(ŷₛ) represents the compression rate.

18. The method according to claim 15, wherein, calculating the weighted loss based on the compression rate, the average distortion, and the average perceptual loss comprises:
determining a weighted loss of a |^{th} synonymous level based on the following expression: [symbol]
x^{(l)}=λ_{d}^{(l)}· [symbol] _{\tilde{x}}_{ⱼ}_{∈}\tilde{x}[d(x,\tilde{x}ⱼ)]+λ_{d}^{(l)}· [symbol] _{\tilde{x}}_{ⱼ}_{∈}\tilde{x}[dₚ(pₓ,p_{\tilde{x}}_{ⱼ})]+λᵣ^{(l)}·R(ŷₛ)
wherein, λ_{d}^{(l)} represents a weighted coefficient of an average distortion of the |^{th} synonymous level; λₚ^{(l)} represents a weighted coefficient of an average perceptual loss of the |^{th} synonymous level; λᵣ^{(l)} represents a weighted coefficient of a compression rate of the |^{th} synonymous level; and R(ŷₛ) represents the compression rate;
determining the weighted loss based on the following expression: [symbol]
ₓ=α⁽¹⁾· [symbol] ₓ⁽¹⁾+α⁽²⁾· [symbol] ₓ⁽²⁾+ . . . +α^{(L)}· [symbol] ₓ^{(L)}
wherein, α⁽¹⁾,α⁽²⁾, . . . α^{(L)} represent weight coefficients corresponding to each synonymous level 1, 2, . . . , L, respectively; and for each l, α^{(l)}≥0.
